(19) United States
(12) Patent Application Publication
(10) Pub. No.: US 2003/0025661 A1
(43) Pub. Date: Feb. 6, 2003

(54) Display device

(76) Inventors: Gerardus Petrus Karman, Eindhoven (NL); Mark Thomas Johnson, Eindhoven (NL); Sjoerd Stallinga, Eindhoven (NL)

Correspondence Address: Michael E. Marion, c/o PHILIPS CORPORATION, Intellectual Property Department, 580 White Plains Road, Tarrytown, NY, 10591, US

(21) Appl. No.: 10/208,679

(22) Filed: Jul. 30, 2002

(30) Foreign Application Priority Data
Aug. 1, 2001 (EP) 01202917.9

(51) Int. Cl. G09G 3/36

(52) U.S. Cl. 345/87

(57) ABSTRACT

Three electrodes (8, 9, 10) per pixel are used instead of the conventional two. In this way, a change of the orientation of LC molecules (3) can be regulated at will so as to obtain faster switching.

The invention relates to a liquid crystal display device comprising a nematic liquid crystal material between two substrates, one of which is provided with a matrix of selection electrodes and data electrodes with a pixel at the area of a crossing of the selection electrodes and data electrodes, and at least a switching element and drive means for driving the selection electrodes and data electrodes.

Examples of such active matrix display devices are the TFT-LCDs or AM-LCDs used in laptop computers and organizers and based on a nematic effect such as the twisted-nematic effect, the in plane switching effect or, for example, the vertically aligned effect.

A problem in such display devices is the comparatively slow switching speed of the pixels; a typical switching period for the liquid crystal molecules is 10-100 msec when switching an electric field. When the electric field is switched off, the periods are usually even longer because the switch-off times are substantially entirely determined by relaxation times. This is notably detrimental when displaying moving images.

It is an object of the invention to provide a more rapidly switching display device of the type described in the opening paragraph.

In a display device according to the invention, the pixel therefore comprises at least three electrodes and the drive means are provided with means for generating, in operation, electric fields in two mutually different directions.

Two mutually substantially perpendicular fields are preferably generated.

The invention is based on the recognition that the switching speed of a pixel depends on the torque exerted by an electric field on the (directors of the) liquid crystal molecules. By activating, with the aid of the drive means, a field exerting a large torque at that instant, a high switching speed can always be achieved, which speed is higher than the switching speed in the case of two electrodes per pixel. Since such a torque can also be generated during switching off, the switch-off time is independent of or hardly dependent on relaxation times.

If necessary, the drive means comprises means for bringing a pixel between two drive periods to a defined state (reset).

A first preferred device comprises a pixel between two substrates, wherein a first substrate comprises two electrodes at the location of the pixel, with a longitudinal direction at an angle. This embodiment is suitable for the in plane switching effect in which a liquid crystal material with a negative dielectric anisotropy is used. The angle is preferably substantially 90 degrees in this case, and the first substrate at the location of the pixel is further provided with a substantially L-shaped electrode.

In a further embodiment, suitable for the twisted-nematic effect (positive dielectric anisotropy), a first substrate comprises two electrodes at the location of the pixel and the second substrate is provided with at least a further electrode.

There are various possibilities of providing the second electrodes with voltages (either at different instants or with different values).

For example, the first substrate comprises two electrodes at the location of the pixel, each electrode being provided with a respective switching element having the selection electrodes in common. If necessary, the switching elements have different switching voltages.

Alternatively, the first substrate may comprise two electrodes at the location of the pixel, each electrode being provided with a respective switching element connected to different selection electrodes.

These and other aspects of the invention are apparent from and will be elucidated with reference to the embodiments described hereinafter.

In the drawings,

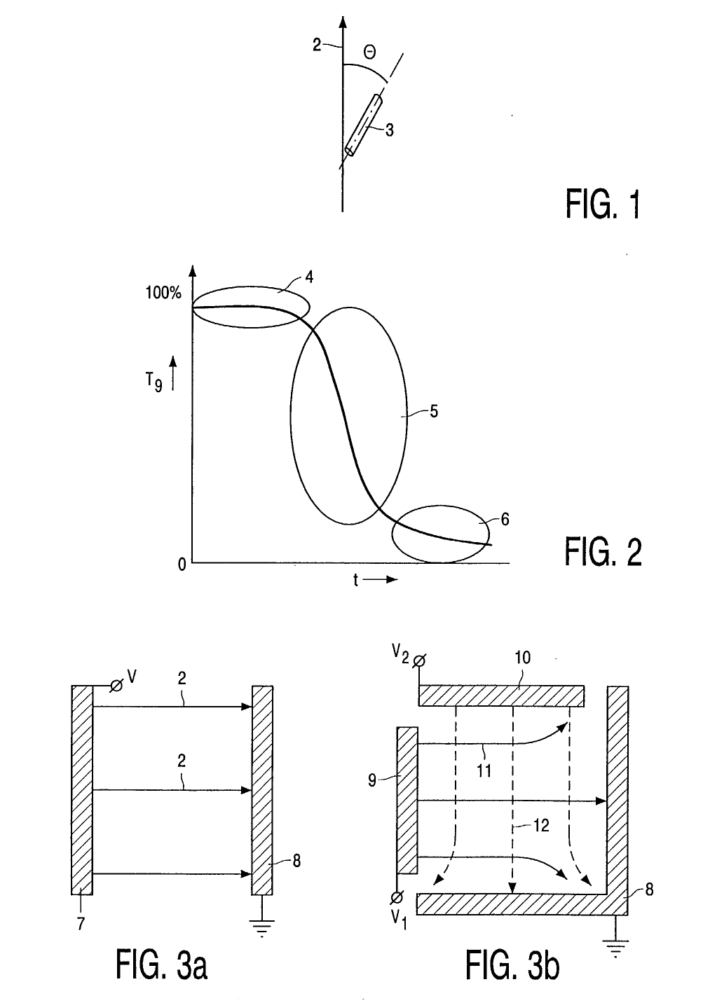

FIGS. 1 and 2 show the effect on which the invention is based,

FIG. 3 is a plan view of picture electrodes in a conventional display device and in a display device according to the invention,

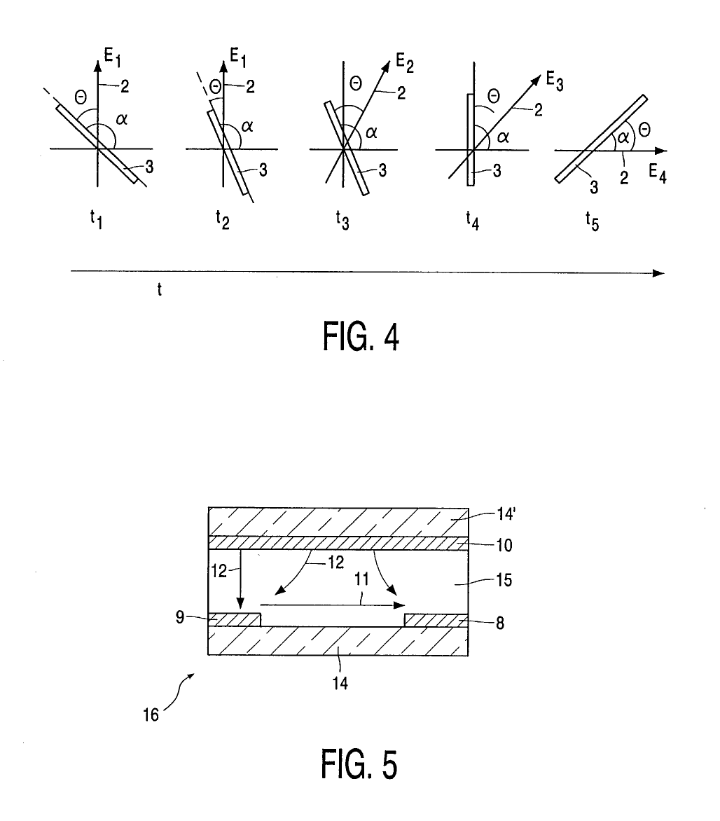

FIG. 4 shows the operation of the invention in the device of FIG. 3, while

FIG. 5 shows a variant of a display device according to the invention,

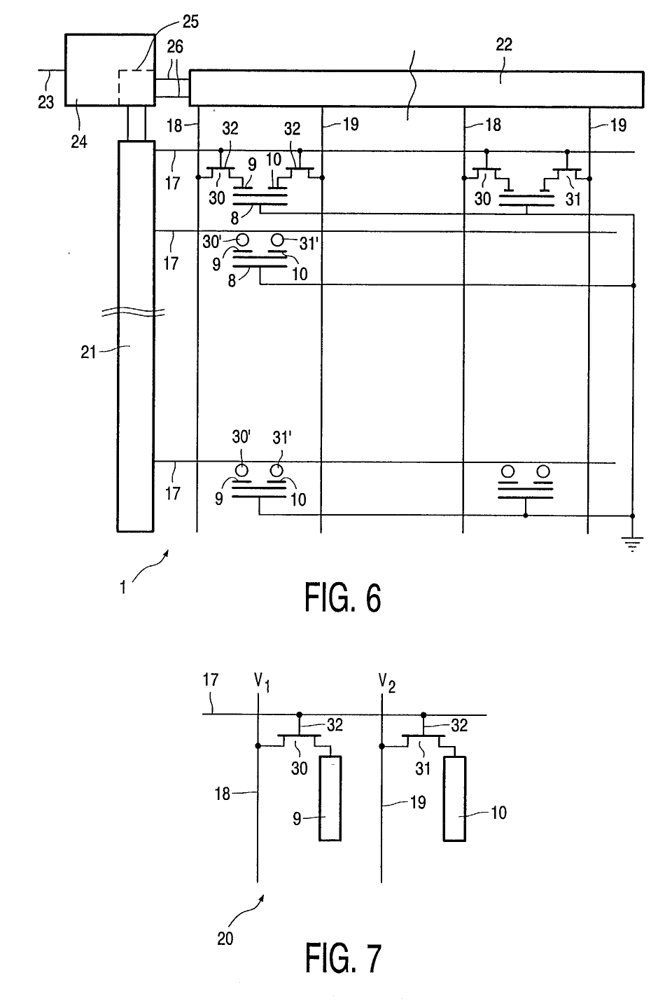

FIG. 6 is an electrical equivalent of a part of a display device according to the invention, while

FIG. 7 shows a detail of FIG. 6, and

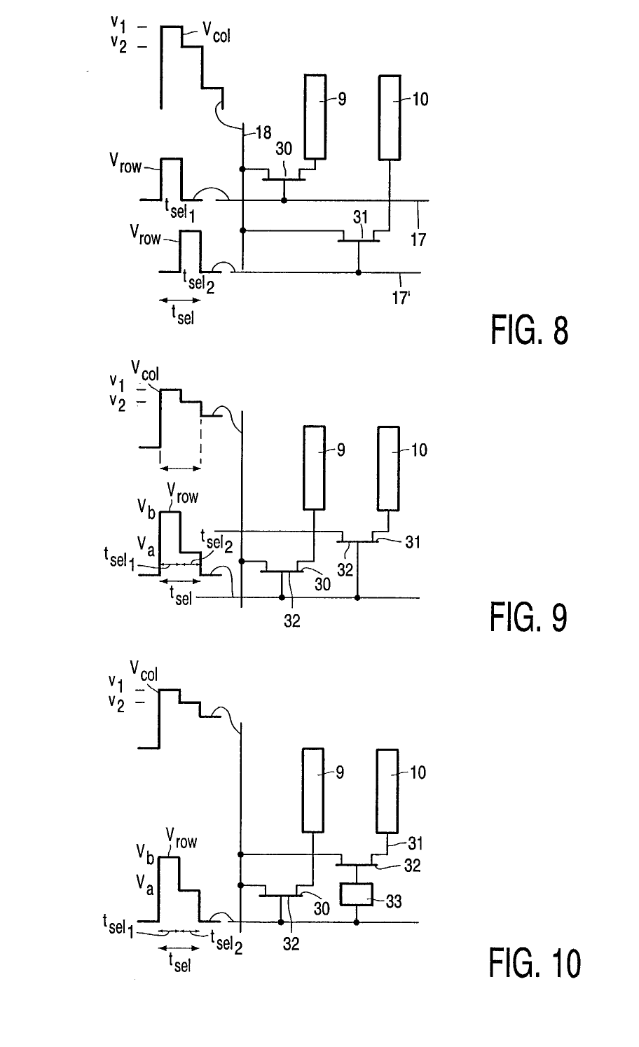

FIGS. 8 to 10 shows variants of FIG. 7.

The Figures are diagrammatic and not drawn to scale; corresponding components are generally denoted by the same reference numerals.

In a liquid crystal display device comprising a nematic material between two substrates, a change of transmission or reflection is obtained because a liquid crystal molecule rotates under the influence of an electric field. The electric field may be supplied transversely to the direction of the substrates or in a direction parallel to the substrates (referred to as In Plane Switching). The switching period of such a display device depends, inter alia, on the viscosity of the liquid crystal material used and the strength of the electric field used.

Another factor, which seems to have much influence, is the torque exerted by the electric field on the (directors of the) liquid crystal molecules. Its value depends on the angle θ between the direction 2 of the prevailing electric field and the direction of the liquid crystal molecule 3 (see FIG. 1). For a liquid crystal material having a negative dielectric anisotropy Δε(Δε=ε_{II}−ε_{⊥}), for example, in a cell based on the in plane switching effect, this torque is proportional to sin(2θ).

When a field is switched on and the molecules are substantially parallel to this field, these molecules will orient themselves under the influence of this field in a direction perpendicular to this field. At first, the angle θ is thus small and the torque will be small; the electric field has little effect and also the transmission (or reflection) of the display cell filled with the liquid crystal material will change only slowly (area 4 in FIG. 2 in which the variation of the transmission with respect to time is shown for such a cell). At an angle θ of about 45 degrees, the electric field is most effective and the transmission changes rapidly (area 5 in FIG. 2) and it changes slowly when the angle θ approaches a value of 90 degrees (area 6 in FIG. 2).

FIG. 3a is a plan view of picture electrodes 7, 8 on a substrate, in which the electrode 8 is connected to a fixed voltage, for example, earth, in a conventional display device for the in plane switching effect in which switching takes place between different optical states by means of electric fields which are directed substantially parallel to the substrate and is therefore referred to as “horizontal electric field display” in which the effect described above occurs.

FIG. 3b is a plan view of picture electrodes 8, 9, 10 on a substrate, in which the electrode 8 is again connected to a fixed voltage, for example, earth, in a display device according to the invention. In this example, the picture electrode 8 is L-shaped, while voltages V₁,V₂ can be supplied by means of the picture electrodes 9, 10. By connecting the electrode 9 to a voltage V₁>0 and the electrode 10 to earth, an electric field, indicated by lines 11, is generated. By connecting the electrode 10 to a voltage V₂>0 and the electrode 9 to earth, an electric field, indicated by lines 11, is generated. Fields of different directions and sizes can be applied by means of mutually different voltages V₁,V₂.

FIG. 4 shows how the molecules 3 switch in an accelerated manner according to the invention.

When the electric field 2 is switched on (E₁ at instant t₁), the molecules 3 extend at an angle α of, for example, 135° to the X axis, while the electric field E₁ is applied at an angle of 90° (V₂>0, V₁=0 in FIG. 3b). The angle θ is then 45° so that the above-mentioned torque is maximal. A molecule 3 will therefore rotate rapidly to the situation where θ≅30° (instant t₂) and α≅120°. Subsequently, the voltages V₁,V₂ are adjusted in such a way (V₂>0, V₁>0) that θ is about 45° again and the torque is maximal (instant t₃, the angle between the electric field 2 and the X axis is about 65°). The molecule 3 now continues to rotate rapidly. By timely adjusting V₁,V₂ in such a way that the torque remains maximal (instant t₄, the angle between the electric field 2 and the X axis is about 45°), the rotation through 90 degrees of the molecules 3 is completed.

Conversely, V₁,V₂ can always be adjusted in such a way that the reverse torque remains maximal when a switching back to the original situation takes place. This switching back has thereby become an actively driven process which is no longer determined by the relaxation time of the liquid crystal molecules.

FIG. 3b shows the electrodes on a first substrate. The liquid crystal molecules are present between this substrate and a second substrate. If desired, one or more (transparent) electrodes may be present on this second substrate.

The dynamic drive described is not limited to the in plane switching effect but may also be used, for example, on display devices 16 (FIG. 5) that are based on the twisted-nematic effect (Δε>0) or on the vertically aligned nematic effect (VAN). The liquid crystal material 15 is present between two substrates 14, 14′. The electrodes 8, 9 on the substrate 17 are suitable for generating electric fields 11 in a direction parallel to the substrates 14, 14′, while electric fields 12 can be applied by means of these electrodes and one or more counter electrodes 10 on the substrate 14′ in a direction transverse to these substrates. By suitable choice of the voltages on the various electrodes, switching on as well as switching off can be accelerated (dynamic drive) similarly as described above.

FIG. 6 shows an electrical equivalent of a part of a display device 1 to which the invention is applicable. It comprises a matrix of pixels 20 at the area of crossings of row or selection electrodes 17 and column or data electrodes 18, 19. The row electrodes are consecutively selected by a row driver 21, while the column electrodes are provided with data via a data register 22. If necessary, incoming data 23 are first processed in a processor 24, if necessary with a signal-processing unit 25. Mutual synchronization between the row driver 21 and the data register 22 takes place via drive lines 26.

Drive signals from the row driver 21 select the picture electrodes 9, 10 (FIG. 3b) via thin-film transistors (TFTs) 30, 31 whose source electrodes are electrically connected to the column electrodes 18, 19. The signals at the column electrodes 18, 19 are transferred via the TFTs 30, 31 to picture electrodes 9, 10, coupled to the drain electrode, of a pixel 20. In this example, the third electrodes of the pixels 20 (electrode 8 in FIG. 3) are connected to earth, but they may be alternatively connected to a variable voltage. For a plurality of pixels 20, the thin-film transistors (TFTs) 30, 31 as well as the associated connections are shown diagrammatically by way of circles 30′, 31′.

FIG. 7 shows how, for a part of a pixel that is comparable with that of FIG. 3b, voltages V₁,V₂ are applied to the column electrodes 18, 19 for the picture electrodes 9, 10 by selecting the associated TFTs 30, 31 via the gate electrodes 32 by means of the row electrode 17. Since in this case each electrode must be provided with separate voltages, a number of column electrodes that is twice as large in comparison with the conventional active matrix drive based on TFTs must be provided.

In FIG. 8, the parts of a pixel that are comparable with those of FIG. 3b are separately selected via the gate electrodes 32, for example, directly after each other for half a selection period, while voltages V₁,V₂ are again applied during the respective selections to the column electrode 18 for the picture electrodes 9, 10. In this case, a number of row electrodes (17, 17′) that is twice as large in comparison with the conventional active matrix drive based on TFTs must be provided. Since the number of rows in a display device is generally smaller than the number of columns (typically a factor of 4), a smaller quantity of extra drive electronics is required in this case than in the configuration of FIG. 7. In both cases, the same type of transistor, for example, an amorphous silicon TFT, is sufficient.

The drawback of a double number of rows or columns can be circumvented by creating a threshold voltage difference for the TFTs 30, 31, as is shown in FIGS. 9 and 10.

In the example of FIG. 9, each picture electrode 9, 10 (FIG. 3b) is selected via thin-film transistors (TFTs) 30, 31, whose gate electrodes 32 are connected in an electrically conducting manner to the row electrodes 17 and the source electrodes are connected to the column electrodes 18 in this case. In this example, the row selection signal is shown as a signal which is divided during a line selection period tₛₑₗ into two substantially equal parts tₛₑₗ₁ and tₛₑₗ₂, with different selection voltages V_{b}, Vₐ. Alternatively, this row selection signal may be realized as, for example, a ramp voltage. The transistors switch due to a switching voltage difference at different row selection voltages. This can be achieved technologically by a variation of the thickness of the gate-oxide layer or by different length-width ratios of the TFT gates, which is possible in the amorphous silicon technology as well as in the polycrystalline silicon technology. This is also possible in the monocrystalline silicon technology, for example, for LCOS circuits, as are used in projection LCD devices, but here (and also in the polycrystalline technology) the desired function can be alternatively realized with CMOS circuits.

During addressing, the row voltage now first gets such a high value (in this example) that both transistors are turned on. In this example, it is assumed that electrode 10 still switches on at the highest selection voltage V_{b} at the row electrode 17; both electrodes then get the voltage V₁. After a very short time (half a line selection period tₛₑₗ₁ in FIG. 9, about 10 microseconds in practice) the voltage at the row electrode 17 and hence at the gate electrodes 32 decreases to a value at which the transistor 31 associated with electrode 10 is turned off or is hardly conducting. Electrode 10 is now insulated and conveys the voltage V₁.

The data voltage changes to V₂ while only transistor 30 is still turned on (during

tₛₑₗ₂ with selection voltage Vₐ at the row electrode 17). After tₛₑₗ, electrode 9 is also insulated and conveys the voltage V₂. In a subsequent (sub-)address period, different voltages are applied to the electrodes 9, 10, so that the process depicted in FIG. 4 is passed through. Since, due to the use of the extra electrode, the molecules rotate much more rapidly than in conventional drive modes, a selection period may consist of a plurality of sub-selection periods or a frame period may consist of a plurality of sub-frames so that a plurality or all of the stages of the process depicted in FIG. 4 are passed through, for example, within the conventional selection period or frame period.

Several variations are of course possible within the scope of the invention. Instead of making use of a threshold voltage difference of the thin-film transistors (TFTs) 30, 31, a resistive or capacitive division may be applied alternatively, as is shown diagrammatically in FIG. 10 by means of the network 33.

A small change of the grey value of the pixel may sometimes suffice to switch only once within a frame period; this decreases the dissipation. The voltages to be used for the electrodes 9, 10 depend, inter alia, on the previous transmission value and the new transmission value of the pixel, the liquid crystal effect used, the temperature and other system properties. Based on these factors, the voltages to be used can be determined by means of signal processing in the processor 24, using, for example, a frame memory, a look-up table, a microprocessor, or the like. The application permitting, the signal processing may only speed up switching on or off.

The invention is of course also applicable to reflective and transflective display devices, while several drive mode variations are also possible.

Where the examples and the explanation of the effect are based on mutually substantially perpendicular fields, the driving fields may be alternatively generated and curved at different angles.

The invention resides in each and every novel characteristic feature and each and every combination of characteristic features. Reference numerals in the claims do not limit their protective scope. Use of the verb “comprise” and its conjugations does not exclude the presence of elements other than those stated in the claims. Use of the article “a” or “an” preceding an element does not exclude the presence of a plurality of such elements.

1. A liquid crystal display device comprising a nematic liquid crystal material between two substrates, one of which is provided with a matrix of selection electrodes and data electrodes with a pixel at the area of a crossing of the selection electrodes and data electrodes, and at least a switching element and drive means for driving the selection electrodes and data electrodes, the pixel comprising at least three electrodes and the drive means being provided with means for generating, in operation, electric fields in two mutually different directions.

2. A liquid crystal display device as claimed in claim 1, wherein two mutually substantially perpendicular fields are generated.

3. A liquid crystal display device as claimed in claim 1, wherein the drive means comprises means for bringing a pixel between two drive periods to a defined state.

4. A liquid crystal display device as claimed in claim 1 or 2, with a pixel between two substrates, wherein a first substrate comprises two electrodes at the location of the pixel, with a longitudinal direction at an angle.

5. A liquid crystal display device as claimed in claim 4, wherein the angle is substantially 90 degrees and the first substrate at the location of the pixel is further provided with a substantially L-shaped electrode.

6. A liquid crystal display device as claimed in claim 1 or 2, with a pixel between two substrates, wherein a first substrate comprises two electrodes at the location of the pixel and the second substrate is provided with at least a further electrode.

7. A liquid crystal display device as claimed in claim 1 or 2, wherein a first substrate comprises two electrodes at the location of the pixel, each electrode being provided with a respective switching element having the selection electrodes in common.

8. A liquid crystal display device as claimed in claim 7, wherein the switching elements have different switching voltages.

9. A liquid crystal display device as claimed in claim 1 or 2, wherein a first substrate comprises two electrodes at the location of the pixel, each electrode being provided with a respective switching element connected to different selection electrodes.
